(19) United States
(12) Patent Application Publication
(10) Pub. No.: US 2020/0230946 A1
(43) Pub. Date: Jul. 23, 2020

(54) TEXTILE DIGITAL PRINTING MACHINE

(71) Applicant: SHENZHEN CNTOP DIGITAL EQUIPMENT CO., LTD., Longgang District Shenzhen, Guangdong (CN)

(72) Inventors: Qixiang Li, Guangdong (CN); Tongze Tang, Guangdong (CN); Shuzhang Liao, Guangdong (CN); Chao Zhang, Guangdong (CN); Kris Otto Friedrich, La Quinta, CA (US); Blair Kristine Dorsey, San Juan Capistrano, CA (US)

(73) Assignee: SHENZHEN CNTOP DIGITAL EQUIPMENT CO., LTD., Longgang District Shenzhen, Guangdong (CN)

(21) Appl. No.: 16/304,728

(22) PCT Filed: Oct. 20, 2017
(86) PCT No.: PCT/CN2017/107061

§ 371 Date: Nov. 27, 2018

(30) Foreign Application Priority Data
Sep. 1, 2017 (CN) 201710777923.1

(51) Int. Cl. B41F 16/00; B41F 19/00; B41F 23/00; B41F 23/04; B41J 3/407

(52) U.S. Cl. CPC B41F 16/0046; B41F 19/007; B41F 23/007; B41P 2217/50; B41J 3/4078; B41P 2217/10; B41F 23/044

(57) ABSTRACT

The present invention provides a textile digital printing machine including: a conveying device; a platen which conveys a textile along with the conveying device; a treatment liquid machine, a drying module, a pressing module and a printing module which are arranged successively along a conveying path of the textile. The treatment liquid machine includes a plurality of spray heads for spraying the treatment liquid onto the textile. The drying module is configured to heat the textile which has been sprayed with the treatment liquid, so that the treatment liquid is absorbed by the textile. The pressing module is configured to press the textile to keep the textile flat and heat the platen. The printing module is configured to spray ink onto the textile to thereby print patterns thereon. The heated platen is configured to dry the ink so that the ink is absorbed by the textile.

### TECHNICAL FIELD

The present disclosure relates to digital printing technology, in particular to a textile digital printing machine for printing patterns on a textile.

### BACKGROUND

A textile printing machine can print patterns on a textile. Upon printing on a conventional textile, the textile is placed on a printing table, and patterns are formed on the textile by brushing ink manually or by an ink-jetting method. However, such a printing method includes a plurality of steps which are operated by different workers, such as placing the textile, brushing ink, adjusting the position to be printed, etc., that is, each step requires one worker to operate, resulting in low degree of automation and low efficiency.

In addition, absorption of ink by the textile depends on an ink absorption characteristic of the textile, when printing patterns by conventionally brushing ink or by an ink-jetting method. The same ink may represent different absorbing time and effect by different textiles, which influences the printing efficiency.

### SUMMARY

The object of the present invention is to provide a textile digital printing machine for solving the problems of low printing efficiency and poor printing effect in the prior art.

The present invention is embodied as follows:

A textile digital printing machine includes a conveying device and a platen being connected to the conveying device and conveying a textile along with movement of the conveying device, and includes a treatment liquid machine, a drying module, a pressing module and a printing module arranged in successively along a conveying path of the textile; the treatment liquid machine includes a plurality of spray heads, which are configured to spray treatment liquid onto the textile;

the drying module is configured to heat the textile which has been sprayed with the treatment liquid, so that the treatment liquid is absorbed by the textile;

the pressing module is configured to press the textile to keep the textile flat and heat the platen;

the printing module is configured to spray ink onto the textile to thereby print patterns thereon;

the heated platen is configured to dry the ink so that the ink is absorbed by the textile.

Further, the treatment liquid machine includes:

a slide rail being disposed in parallel to the platen;

a treatment liquid spraying module positioned slidably on the slide rail;

the treatment liquid spraying module includes a plurality of spray heads, control valves connected to the spray heads and a container with the treatment liquid stored therein;

the control valve is opened when the treatment liquid spraying module slides on the slide rail, so that the spray heads spray the treatment liquid.

Further, the treatment liquid machine includes a driving motor, which drives the treatment liquid spraying module to slide with respect to the slide rail, and a control module;

the control module controls the control valve to be opened and closed.

Further, the plurality of spray heads are aligned perpendicularly to a lengthwise direction of the slide rail, each of the control valves controls one of the spray heads to be opened and closed.

Further, the drying module includes:

a lampshade;

heating lamps fixed within the lampshade and disposed toward the textile;

reflector caps each disposed outside of each heating lamp with an angle of reflection towards the textile;

lights emitted by the heating lamps are reflected toward the textile by the reflector caps to dry the treatment liquid on the textile and allow the treatment liquid to be absorbed by the textile.

Further, there is a plurality of the drying modules, and the plurality of drying modules are distributed along a conveying path of the conveying device.

Further, the pressing module includes:

a frame;

a driving cylinder which is positioned on the frame at one end thereof and which is stretchable with respect to the frame;

a pressing plate being parallel to the platen and fixed to the other end of the driving cylinder;

the pressing plate moves with respect to the frame when the driving cylinder stretches, thereby pressing the textile on the platen to heat the platen and the textile.

The printing module includes:

a guide rail beam intersecting with the conveying direction of the conveying device; a first printing carriage which is disposed on one side of the guide rail beam and is slidable along an extending direction of the guide rail beam;

a second printing carriage which is disposed on the other side of the guide rail beam and is slidable along the extending direction of the guide rail beam; each of the first printing carriage and the second printing carriage includes a plurality of printing nozzles configured to spray ink, the first printing carriage is configured to print background of an pattern on the textiles, and the second printing carriage is configured to print color on the background of the pattern, the color covers the background.

a driving device driving the first printing carriage and the second printing carriage to move along the extending direction of the guide rail beam so as to slide over the textile to print patterns thereon;

the patterns printed on the same textile by the first printing carriage and the second printing carriage have same shape.

Further, patterns printed by the first printing carriage in two continuous printings are of different shapes, while a pattern printed by the second printing carriage in a latter printing has the same shape with a pattern printed by the first printing carriage in a former printing.

Further, the conveying device has a closed loop, and there are a plurality of the platens arranged with interval in a conveying direction of the conveying device; the conveying device conveys one platen each time in a stepwise manner.

The textile digital printing machine in this invention spray the treatment liquid onto the textile via the treatment liquid machine, and the treatment liquid is rapidly absorbed by the textile through the drying module and the pressing module, and thereafter the ink is sprayed on the textile to form a printed pattern. The invention enables the ink to be rapidly absorbed to form a pattern while improving the printing quality of the pattern through the treatment liquid. The pressing module allows the platen to have a certain amount of heat, and the heat of the platen can further enable the rapid absorption of the ink, thereby improving the efficiency of the ink absorption and enhancing printing efficiency.

### DRAWINGS

The drawings of the embodiments or the description in the prior art will be described below, in order to explain more clearly the embodiments in the present invention or the technical solutions in the prior art. Apparently, the drawings in the following description are only some exemplified embodiments of the present invention.

FIG. 1 is a structural schematic diagram of a textile digital printing machine according to the present invention;

FIG. 2 is a top view of FIG. 1;

FIG. 3 is a structural schematic diagram of a treatment liquid machine according to the present invention;

FIG. 4 is a structural schematic diagram of drying modules according to the present invention;

FIG. 5 is a structural schematic diagram of a pressing module according to the present invention;

FIG. 6 is a structural schematic diagram of a printing module according to the present invention.

### DETAILED DESCRIPTION

The technical solutions in the embodiments of the present invention will be described clearly and completely in the following, with reference to the accompanying drawings in the embodiments of the present invention. It is obvious that the embodiments described are only a part of the embodiments of the present invention, not all embodiments. All other embodiments obtained by those skilled in the art based on the embodiments of the present invention without creative efforts fall within the scope of the present invention.

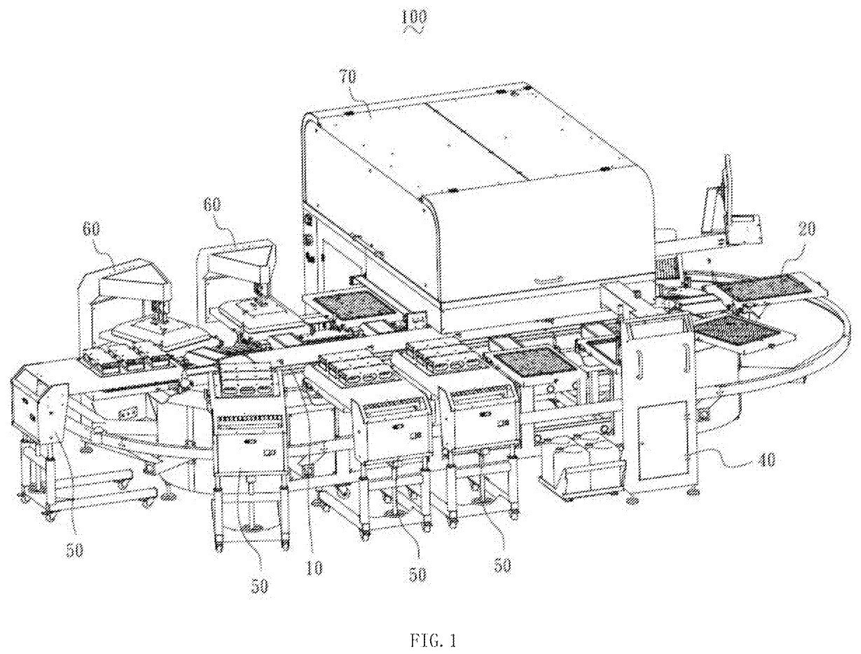

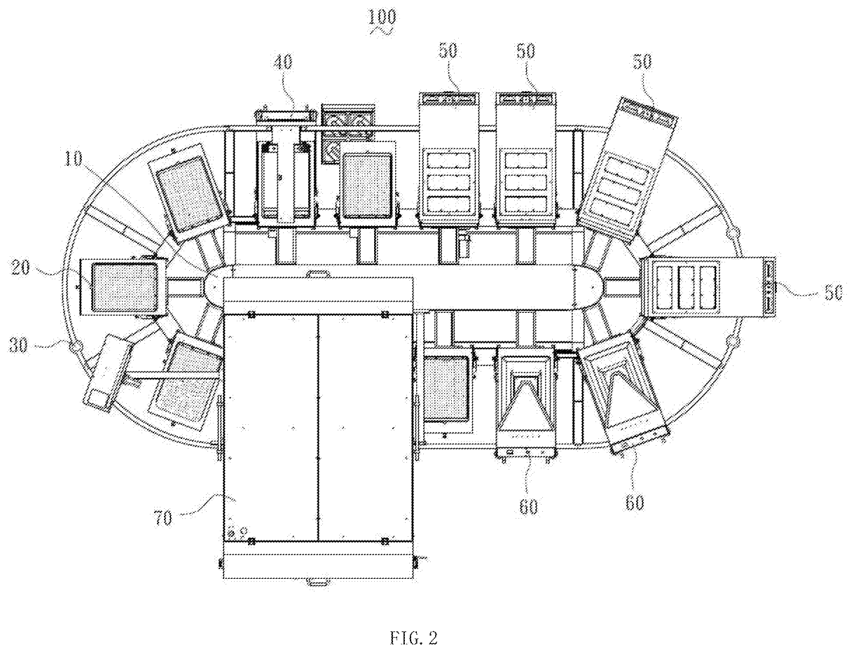

With reference to FIGS. 1 and 2, an embodiment of the present invention provides a textile digital printing machine 100 for printing patterns on textiles, in particular, the textile digital printing machine 100 includes a conveying device 10 and a plurality of platens 20 which move along with the conveying device 10 to convey textiles. The plurality of platens 20 are arranged with interval in a conveying direction of the conveying device 10. The conveying device 10 conveys one platen 20 each time in a stepwise manner. The textiles are fixed on the platen 20. The platens 20 move on the conveying device 10 to convey the textiles from one position to another position, so as to complete a plurality of printing processes. The plurality of positions include a starting position, at which a control button 30 is arranged. The control button 30 is electrically connected to the conveying device 10 to control the operation and stop of the conveying device 10. The platen 20 moves from one position to another position when the conveying device 10 is in operation. At the starting position, the textile is fixed to the platen 20 by an operator. The operator presses the control button 30 after the textile is fixed, and the conveying device 10 operates to drive the platen 20 to a next position.

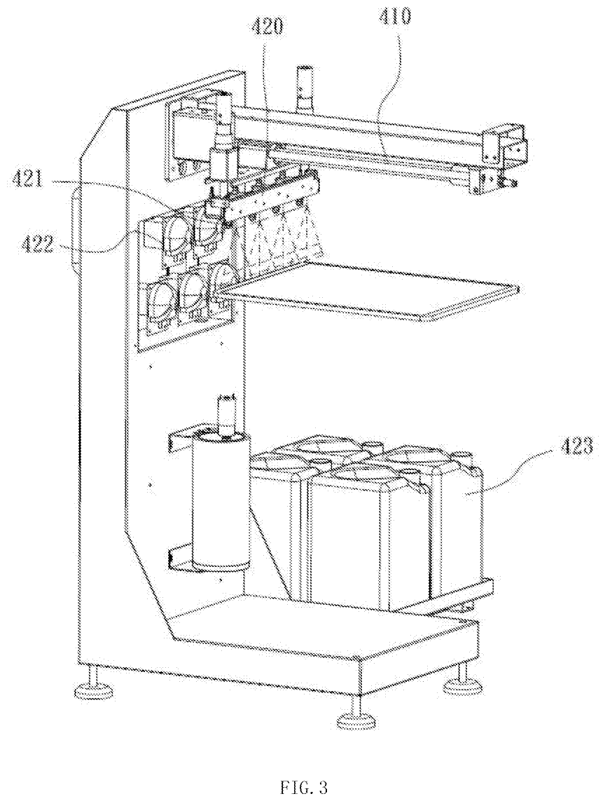

As illustrated in FIG. 3, the textile digital printing machine 100 further includes a treatment liquid machine 40 for receiving the textile fixed on the platen 20 at the starting position, and spray a treatment liquid onto the textile on the platen 20. The treatment liquid is a liquid, which covers fluffs extending from a yarn of the textile after being sprayed onto the textile, preventing the sprayed ink from hanging on the fluffs without being absorbed by the textile, as such non-absorbing may result in the poor quality of the printed pattern. Meanwhile, the treatment liquid penetrates into the textile, thereby improving the ability of anti-penetration of the textile, enhancing the covering power of the ink and its adhesion with the treatment liquid, and preventing the decoloration in the printed pattern. In addition, the treatment liquid enables the ink sprayed onto the textile to be uniform. In particular, the treatment liquid machine 40 includes: a slide rail 410 being parallel to the platen 20 and a treatment liquid spraying module 420 positioned and sliding on the slide rail 410, the treatment liquid spraying module 420 sprays the treatment liquid during sliding from one end of the slide rail 410 to the other end.

The treatment liquid spraying module 420 includes: a plurality of spray heads 421 and a container 423 connected to the spray heads 421 through a plurality of control valve 422, the treatment liquid is stored in the container 423. The control valves 422 correspond to a spray head 421 one-to-one. The control valves 422 are configured to control the opening and closing of the spray heads 421. The spray heads 421 spray the treatment liquid and the treatment liquid spraying module 420 moves from one end of the slide rail 410, when the control valves 422 are open. The control valves 422 are closed and the spray heads 421 stop spraying the treatment liquid, when the area to be printed is completely covered by an area, onto which the treatment liquid is sprayed by the treatment liquid spraying module 420.

In an embodiment of the present invention, the control valves 422 are connected with a control module. The control module controls the number of opened control valves 422 and the opening duration of the control valves 422 based on a received control command, and thereby determines the size and location of the area, onto which the treatment liquid is to be sprayed.

The plurality of spray heads 421 are aligned perpendicularly to a lengthwise direction of the slide rail 410. The plurality of the spray heads 421 are controlled by the plurality of the control valves 422, respectively, to be open or closed. The number of the spray heads 421 to be opened is set according to the size of the area onto which the treatment liquid is to be sprayed. The number of opened spray heads 421 is large when the width of the area, onto which the treatment liquid is to be sprayed, is large. The width of the area to be sprayed is largest when all the spray heads 421 are opened. The width of the area to be sprayed is smallest when the number of the opened spray heads 421 is small.

In an embodiment of the present invention, the maximum length of the area, onto which the treatment liquid is to be sprayed, is a length of the slide rail 410. The treatment liquid spraying module 420 sprays the treatment liquid while sliding on the slide rail 410.

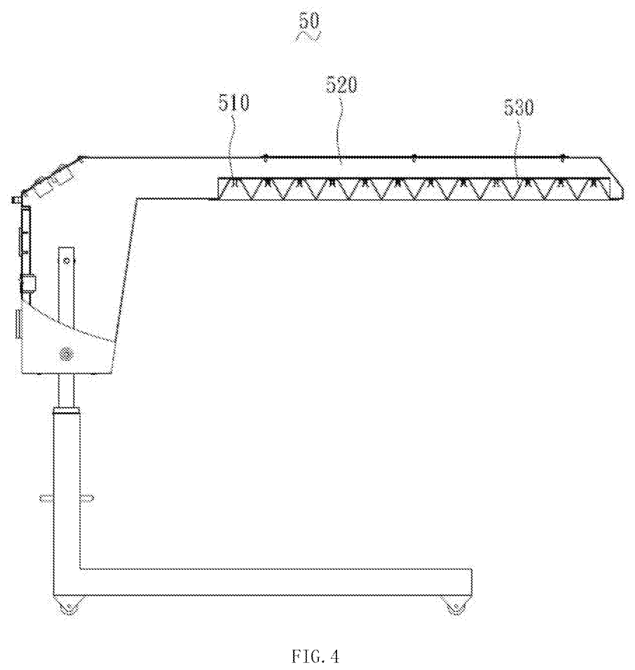

As illustrated in FIG. 4, the textile digital printing machine 100 further includes drying modules 50 configured to dry the textile sprayed with the treatment liquid, allowing the treatment liquid on the textile to be absorbed by the textile. The treatment liquid penetrates into the textile, thereby preventing the ink sprayed on the textile from penetrating through. It is possible to improve the printing effect of the ink on the textile and increase the printing efficiency.

In particular, the drying modules 50 includes: a plurality of heating lamps 510 disposed in parallel to the textile, and the heating lamps 510 are fixed in a lampshade 520 and disposed toward the textile. The plurality of heating lamps 510 evaporate the moisture in the treatment liquid by generating heat through light, while the treatment liquid is absorbed by the textile.

On each heating lamp 510, a reflector cap 530 is disposed outside of the heating lamp 510. The angle of reflection of the reflector cap 530 is directed toward the textile. The heating light generated by the heating lamp 510 is reflected by the reflector 530 onto the textile so as to achieve a heating effect.

There are a plurality of drying modules 50 disposed at a plurality of positions along the conveying direction of the conveying device 10. The textile is heated and dried by the plurality of drying modules 50 successively. This results in good drying effect and is advantageous to save drying time.

In an embodiment of the present invention, preferably, there are three drying modules 50.

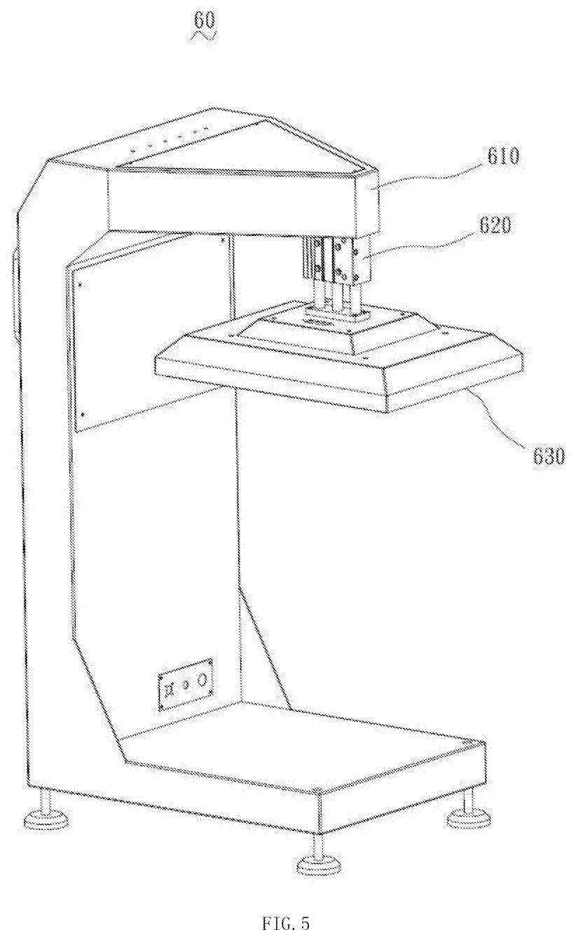

As shown in FIG. 5, the textile digital printing machine further includes at least one pressing module 60, which includes a heated pressing plate 610 disposed in parallel to the textile. The pressing plate 610 is pressed against the textile when the dried textile absorbing treatment liquid is conveyed to the pressing module 60, so that the treatment liquid is completely absorbed by the textile, while the flatness of the textile is improved and the textile is prevented from wrinkling.

In particular, the pressing module 60 further includes a driving cylinder 620, with a driving end fixed on one side of the pressing plate 610 and the other end fixed on a frame 630. The driving cylinder 620 drives the pressing plate 610 to descend and rise. The pressing plate 610 is pressed against the textile when it is pressed down.

In the present invention, the pressing plate 610 heats the textile and the platen 20 on which the textile is fixed, while being pressed against the textile to improve the flatness. Thereby, there is a certain amount of heat on the platen 20 for the textile and the surface of the textile. The heated textile is advantageous to the absorption of the ink sprayed onto the textile, so that the ink is dried, the absorption time is reduced and the printing efficiency is increased.

In the present invention, by increasing the flatness of the textile, it is advantageous to enhance the precision for spraying the ink. Therefore, it is possible to prevent the ink from being deviated due to the wrinkling of the textile, as such deviation may result in the poor effect of printing pattern.

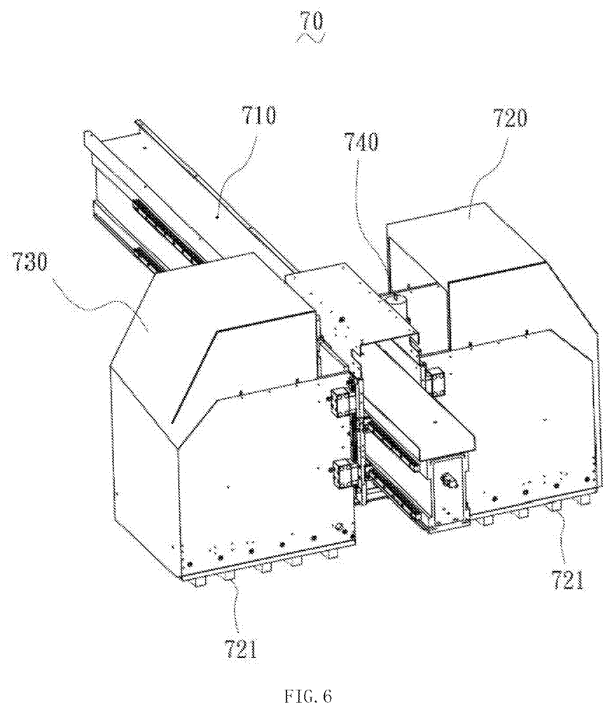

As shown in FIG. 6, the textile digital printing machine 100 in present invention also includes a printing module 70. The printing module 70 includes a guide rail beam 710, a first printing carriage 710, a second printing carriage 730 and a driving device 740. The first printing carriage 720 is disposed on one side of the guide rail beam 710 and slides along an extending direction of the guide rail beam 710, for printing a background of the pattern on the textile. The second printing carriage 730 is disposed on other side of the guide rail beam 710 and slides along the extending direction of the guide rail beam 710, for printing colors of the pattern on the pattern printed with the background. The colors cover the background. The first printing carriage 720 and the second printing carriage 730 are located at two adjacent positions, respectively. The first printing carriage 720 and the second printing carriage 730 both include a plurality of spray heads 721 for spraying the ink to form the pattern on the textile.

The driving device 740 is configured to drive the first printing carriage 720 and the second printing carriage 730 to move along the extending direction of the guide rail beam 710, so as to slide over the textile to perform printing of the patterns. The shape of the patterns printed on the same textile by the first printing carriage 720 and the second printing carriage 730 are identical.

The extending direction of the guide rail beam 710 intersects with the conveying direction of the printing medium. In the present embodiment, the conveying direction of the textile is perpendicular to the extending direction of the guide rail beam 710, and the conveying direction of the textile is a direction from the first printing carriage 720 to the second printing carriage 730.

The textile is conveyed along a perpendicular direction to the guide rail beam 710, and is stopped after being conveyed below the first printing carriage 720. The driving device 740 drives the first printing carriage 720 to move along the extending direction of the guide rail beam 710, and print a predetermined first pattern with the background on the textile. After the printing of the first pattern is completed, the textile continues to be conveyed to another adjacent position, i.e. below the second printing carriage 730, and at this time, the second printing carriage 730 prints a second pattern in colors on the textile on which the first pattern has been printed. The second pattern covers the first pattern, and has the same shape and style with the first pattern. The color of the background of the first pattern is white. Printing colors on the background can prevent the colored pattern from poor expressiveness, unclearness and blur, and poor layering in colors due to printing the patterns with colors directly on the textile while the color of the background of the textile is relatively dark.

In the present invention, the shape of the first pattern sent to the first printing carriage 720 and the second pattern sent to the second printing carriage 730 by the control system, through the software program, are the same, in the process of the same textile being printed by the first printing carriage 720 and the second printing carriage 730 at two forward and rearward positions. The first pattern and the second pattern are different in color. Thereby, after being printed once, the second pattern is completely superimposed on the first pattern. This prevents the first pattern from leakage and influence on the printing quality, under the condition of ensuring the color saturation and contrast ratio of the printed patterns.

In other embodiments of the present invention, the shapes of the patterns printed by the first printing carriage 720 are different at two continuous printings, i.e., a former printing and a latter printing. The shape of the pattern printed by the second printing carriage 730 at the latter printing is the same as that printed by the first printing carriage 720 at the former printing.

In particular, in the printing processes of two pieces of textiles passing through the same position, the first patterns for the two pieces of textiles sent by the control system to the first printing carriage 720 through the software program at two continuous printings, i.e., the former printing and the latter printing), are different. In particular, when the first textile is printed by the first printing carriage 720, the first printing carriage 720 prints the first pattern (A) with white ink, and after the printing is completed, the first textile is transported by the conveying device 10 to the next position, that is, below the second printing carriage 730. Then, the second printing carriage 730 prints a second pattern (A), which are in the same shape with the first pattern (A), with color ink onto the first textile, and the colored second pattern (A) covers the whole first pattern (A). The first printing carriage 720 prints a first pattern (B) onto the second textile below the position thereof with white ink while the second printing carriage 730 is printing the second pattern (A). The conveying device 10 transports the second textile, which has been printed with the first pattern (B) with white ink, to a position below the second printing carriage 730 after the printing of the second pattern (A) on the first textile is completed by the second printing carriage 730, and the second printing carriage 730 prints the second pattern (B) with color ink on the second textile. Meanwhile, a third textile is transported to the position below the first printing carriage 720, and the first printing carriage 720 prints a corresponding pattern with white ink on the third textile. The first and second printing carriages 720 and 730 print patterns on the plurality of textiles according to the above printing and conveying manners. The textile digital printing machine 100 in the present invention further includes an end position at which the printed textiles are removed from the platen 20 and are stored. At this point, the entire printing process is finished.

In the present invention, the conveying device 10 has a closed loop, and there are a plurality of platens 20 disposed with interval on the conveying device 10. The plurality of platens 20 move simultaneously while one platen 20 moves from one position to another position. In present invention, the start position and the end position coincide, thereby only one operator is required to remove the printed textile from the platen 20 at the starting position, and then fixes the unprinted textile onto the platen 20. Only one operator is required for the entire textile printing machine 100. This saves costs, and the whole printing process is an automatic process without brushing ink or the treatment liquid manually, thereby improving the production efficiency.

In the present invention, only one operator is required to put on and remove the textile from the platen 20 and press the operation button at the same time to start the entire conveying device 10. The textile on the platen 20 is transported by the conveying device to pass through the treatment liquid spraying module 420, the drying modules 50, the pressing modules 60 and the printing module 70, and the printing of patterns thereof is completed automatically by the first printing carriage 720 and the second printing carriage 730. The whole process is automatic without manual operation; therefore manpower is saved and the production efficiency is improved.

The above are only the embodiments of the present invention, and are not intended to limit the present invention. Any modifications, equivalents, improvements, etc., which fall within the spirit and scope of the present invention, should be included therein.

1. A textile digital printing machine including a conveying device and a platen connected to the conveying device and conveying a textile along with movement of the conveying device, wherein the textile digital printing machine including a treatment liquid machine, a drying module, a pressing module and a printing module arranged successively along a conveying path of the textile;
the treatment liquid machine includes a plurality of spray heads configured to spray treatment liquid onto the textile;
the drying module is configured to heat the textile which has been sprayed with the treatment liquid, so that the treatment liquid is absorbed by the textile;
the pressing module is configured to press the textile to keep the textile flat and heat the platen;
the printing module is configured to spray ink onto the textile to thereby print patterns thereon;
the heated platen is configured to dry the ink so that the ink is absorbed by the textile.

2. The textile digital printing machine of claim 1, wherein the treatment liquid machine includes:
a slide rail disposed in parallel to the platen;
a treatment liquid spraying module positioned slidably on the slide rail;
the treatment liquid spraying module includes a plurality of spray heads, control valves connected to the spray heads and a container with the treatment liquid stored therein;
the control valve is opened when the treatment liquid spraying module slides on the slide rail, so that the spray heads spray the treatment liquid.

3. The textile digital printing machine of claim 2, wherein the treatment liquid machine includes a driving motor which drives the treatment liquid spraying module to slide with respect to the slide rail, and a control module;
the control module controls the control valve to be opened and closed.

4. The textile digital printing machine of claim 2, wherein the plurality of spray heads are aligned perpendicularly to a lengthwise direction of the slide rail, each of the control valves controls one of the spray heads to be opened and closed.

5. The textile digital printing machine of claim 1, wherein the dry module includes:
a lampshade;
heating lamps fixed within the lampshade and disposed toward the textile;
reflector caps each disposed outside of each heating lamp with an angle of reflection towards the textile;
lights emitted by the heating lamps are reflected towards the textile by the reflector caps to dry the treatment liquid on the textile to allow the treatment liquid to be absorbed by the textile.

6. The textile digital printing machine of claim 5, wherein there are a plurality of the drying modules to be distributed in a conveying path of the conveying device.

7. The textile digital printing machine of claim 1, wherein the pressing module includes:
a frame;
a driving cylinder which is positioned on the frame at one end thereof and which is stretchable with respect to the frame;
a pressing plate being parallel to the platen and fixed to the other end of the driving cylinder;
the pressing plate moves with respect to the frame when the driving cylinder stretches, thereby pressing against the textile on the platen to heat the platen and the textile.

8. The textile digital printing machine of claim 1, wherein the printing module includes:
a guide rail beam disposed intersecting with a conveying direction of the conveying device;
a first printing carriage which is disposed on one side of the guide rail beam and is slidable along an extending direction of the guide rail beam;
a second printing carriage which is disposed on the other side of the guide rail beam and is slidable along the extending direction of the guide rail beam; each of the first printing carriage and the second printing carriage includes a plurality of printing nozzles configured to spray ink, the first printing carriage is configured to print background of an pattern on the textile, and the second printing carriage is configured to print color on the background of the pattern, the color covers the background;
a driving device driving the first printing carriage and the second printing carriage to move along the extending direction of the guide rail beam so as to slide over the textile to print patterns thereon;
the patterns printed on the same textile by the first printing carriage and the second printing carriage have the same shape.

9. The textile digital printing machine of claim 8, wherein patterns printed by the first printing carriage in two continuous printings are of different shapes, while a pattern printed by the second printing carriage in a latter printing has the same shape with a pattern printed by the first printing carriage in a former printing.

10. The textile digital printing machine of claim 1, wherein the conveying device has a closed loop, and there are a plurality of the platens arranged with interval in a conveying direction of the conveying device; the conveying device conveys one platen each time in a stepwise manner.
